(19) United States
(12) Patent Application Publication
(10) Pub. No.: US 2003/0030371 A1
(43) Pub. Date: Feb. 13, 2003

(54) Organic light emitting backlight device for liquid crystal display

(75) Inventors: Tsung-Neng Liao, Taichung Hsien (TW); Yuan-Tung Dai, Chung Li City (TW); Chu-Jung Shih, Taipei (TW)

Correspondence Address: LOWE HAUPTMAN GOPSTEIN GILMAN & BERNER, LLP, Suite 310, 1700 Diagonal Road, Alexandria, VA, 22314, US

(73) Assignee: INDUSTRIAL TECHNOLOGY RESEARCH INSTITUTE

(21) Appl. No.: 09/927,530

(22) Filed: Aug. 13, 2001

(51) Int. Cl. H01J 1/62

(52) U.S. Cl. 313/506

(57) ABSTRACT

An organic backlight device for liquid crystal display application is provided. The organic backlight device has organic light emitting layers, which are arranged in such as linear arrangement and controlled by a driving circuit, to emit light at least three different bandwidths by turns, for example, in red, green and blue bandwidths. By emitting light with a high frequency by turns, persistence of color vision is produced to a viewer. A thin and light backlight source with high brightness and uniformity is therefore obtained.

### FIELD OF THE INVENTION

The present invention relates to liquid crystal display (LCD), and more particularly to a color organic light emitting backlight device with sequential color mode for LCD, which can provide a stable and bright backlight source.

### BACKGROUND OF THE INVENTION

Since the field of multimedia applications is developing quickly, the user has a great demand for entertainment equipment. Conventionally, the cathode ray tube (CRT) display, which is a species of monitor, is commonly used. However, the cathode ray tube display does not meet the needs of multimedia technology because of having a large volume. Therefore, many flat panel display techniques such as liquid crystal display (LCD), plasma display panel (PDP) and field emission display (FED) have been recently developed. These display techniques can manufacture a thin, light, short and small monitor, and thus these techniques are going to be the mainstream technology for the future.

In these techniques, liquid crystal display (LCD) is greatly improved from a black-white display to a full color display, and is popularly utilized in a great variety of image display, such as in personal computers, notebook computers, digital watches, telephones, personal digital assistants (PDA), or the like portable electronic equipment. Most of conventional LCD must use a large backlight module to provide a substantial amount of light through the liquid crystal panel to the eyes of a viewer, and to produce a suitable viewing.

In the past years, fluorescent lamps are generally utilized to provide backlight source for LCD. Typically, a large fluorescent backlight module can work very well at lighting a large direct view LCD, but large volume and heavy weight, higher than 15% of the displaying panel, limits size choice and usefulness of the LCD. As a general rule, as the length and diameter of the fluorescent lamps decrease, the efficiency also decreases, and therefore damages the viewing display result. Hence, the manufacture of LCD has a great limitation caused from the backlight source module.

Typically, red, green and blue (RGB) lights are employed as base components for full color displaying. When a fluorescent backlight module with white light source is used, a color filter must be fitted to filter the white light and to provide RGB light sources. However, the color filter absorbs most of the light, so that light transmittance is greatly decreased, and thus utility performance of light is decreased and more amount of white light is needed.

Hence, it becomes an important object to color liquid crystal development of how to provide a high performance and stable full color backlight source with weightless and small volume.

### SUMMARY OF THE INVENTION

The present invention provides an organic backlight device for liquid crystal display, which includes organic light emitting layer to shorten the distance between the liquid crystal layer and backlight device and to provide a thin, light, high bright and stable color backlight source.

In one aspect, the present invention provides a color organic light emitting backlight device for liquid crystal display. The color organic light-emitting device comprises a transparent substrate, at least three blocks of first conductive layer, at least three blocks of organic light emitting layer and a second conductive layer. The at least three blocks of first conductive layer are disposed on the transparent substrate. The at least three blocks of organic light emitting layer are disposed on the blocks of first conductive layer and fully cover the blocks of first conductive layer, respectively. The at least three blocks of organic light emitting layer emit at least three different bandwidths of light by turns. The second conductive layer is deposed and fully covers the blocks of organic light emitting layer.

In another aspect, the present invention provides a color organic light-emitting device for liquid crystal display adapted for a transparent substrate. The color organic light-emitting device comprises at least three organic light emitting regions of which emit at least three different bandwidths of light by turns. Each of the organic light emitting regions comprises a first conductive layer, an organic light emitting layer and a second conductive layer. The first conductive layer is disposed on the transparent substrate. The organic light emitting layer is disposed on the first conductive layer and fully covers the first conductive layer. The second conductive layer is disposed on the organic light emitting layer and fully covers the organic light emitting layer.

Wherein, the blocks of organic light emitting layer or the organic light emitting regions can be arranged in a linear arrangement. The organic light emitting backlight device further comprises a driving circuit that drives the organic light emitting layers to emit individual light by turns. The at least three different bandwidths of light comprises the light in red (R), green (G) and blue (B) bandwidths, which they are emitted by turns with a frequency three times a scanning frequency, and the scanning frequency is higher than 60 Hz.

The color organic light emitting backlight device includes organic light emitting layers with which operated by sequential color mode at high frequency. Persistence of color vision is produced to a viewer, and thereby a thin, light and high bright color backlight source is provided.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a schematic cross-sectional view of the first preferred embodiment of the present invention;

FIG. 2 is a schematic top view illustrated one preferred arrangement of the organic light emitting backlight device of the present invention;

FIG. 3 is a schematic cross-sectional view of a modified embodiment corresponding to the first preferred embodiment of the present invention;

FIG. 4 is a schematic cross-sectional view of the second preferred embodiment of the present invention; and

FIG. 5 is a schematic cross-sectional view of a modified embodiment corresponding to the second preferred embodiment of the present invention.

### DETAILED DESCRIPTION OF THE PREFERRED EMBODIMENT

The present invention provides a color organic light emitting backlight device with which operated by sequential color mode. The distance of the liquid crystal layer and the backlight device can be greatly shortened, and light dissipation can be minimized. By high frequently emitting organic light emitting layers by turns, persistence of color vision is provided to a viewer. Therefore, a thin, light, high bright color backlight source can be provided.

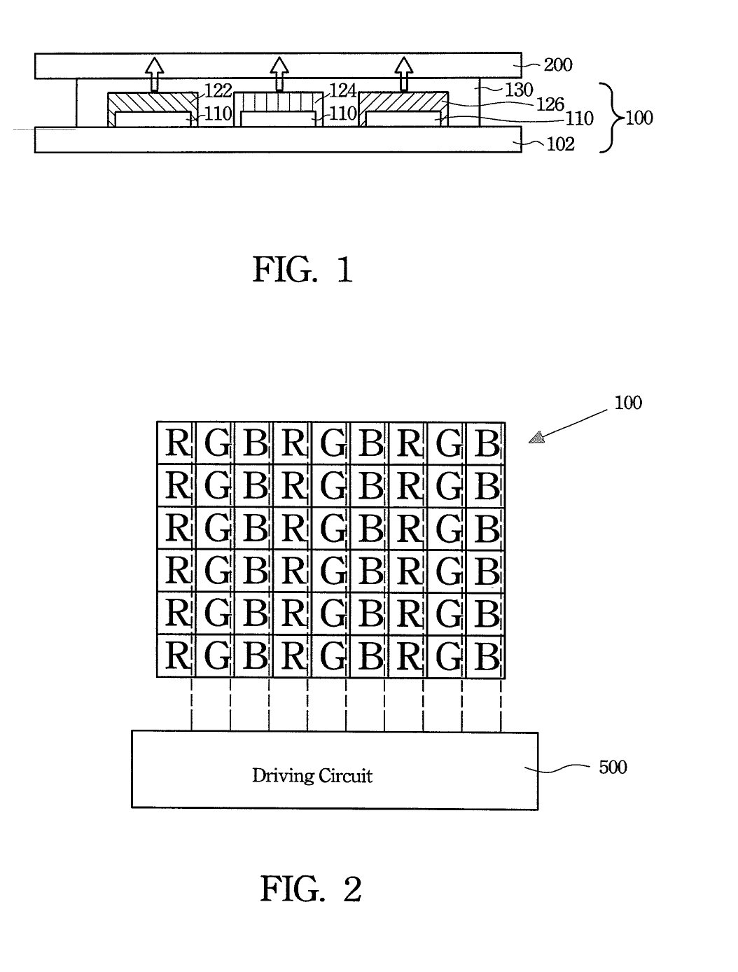

FIG. 1 is a schematic cross-sectional view of the first preferred embodiment of the present invention. The color organic light emitting backlight device of the present invention can be applied to a liquid crystal display to serve as the backlight source. Referring to FIG. 1, the organic light emitting backlight device 100 of the present invention comprises a transparent substrate 102. The transparent substrate 102 can be made of a high transparence material, such as glass, plastic, or quartz, etc. At least three blocks of first conductive layer 110 are formed on the transparent substrate 102 to serve as an electron injection layer (EIL), and all of the blocks of first conductive layer 110 are not contacted to each other. The first conductive layer 110 can be made of a conductive material with low work function, for example, lithium (Li), magnesium (Mg), calcium (Ca), and aluminum (Al), etc.

At least three blocks of organic light emitting layer 122, 124, 126 are formed on the blocks of first conductive layer 110, and fully cover the blocks of first conductive layer 110, respectively. The blocks of organic light emitting layer 122, 124, 126 can be made of organic light emitting material or polymer light emitting material. The blocks of organic light emitting layer 122, 124, 126 respectively emit at least three different bandwidths of light. The at least three different bandwidths of light must be components for constructing full color vision, for example, the light in red, green and blue (RGB) bandwidths, the light in cyan, magenta and yellow (CMY) bandwidths, or other component combination for full color vision.

A second conductive layer 130 formed on the blocks of organic light emitting layer 122, 124, 126 is a transparent conductive layer, and fully covers the blocks of organic light emitting layer 122, 124, 126 to server as a hole injection layer (HIL). The second conductive layer 130 can be made of a transparent conductive material with high work function, such as indium tin oxide (ITO). Therefore, the light emitted from the blocks of organic light emitting layer 122, 124, 126 can be transmitted through the second conductive layer 130 to a liquid crystal displaying module 200. As well known to a person of ordinary skill in the art, the liquid crystal displaying module 200 at least includes a liquid crystal layer, polarizers, and a switch circuit, etc., to control whether the light emitted from the organic light emitting backlight device 100 passes through the liquid crystal displaying module to the eyes of a viewer.

Referring to FIG. 2, it illustrates a top view of one preferred arrangement of the organic light emitting backlight device of the present invention. In the organic light emitting backlight device 100 of the present invention, each organic light emitting region is composed of a block of first conductive layer 110, a block of organic light emitting layer 122, 124 or 126, and a corresponding block of second conductive layer 130 thereon. The organic light emitting regions are the regions of R, G and B as shown in FIG. 2. Each organic light emitting region is correspondingly mapped to a pixel on the liquid crystal displaying module 200, and the total integration can be increased. The blocks of organic light emitting layer 122, 124, 126 can be in a variation of arrangement, including linear, tripolar, mosaic or four-pixel arrangement, and preferably in a linear arrangement, as shown in FIG. 2. In the preferred embodiment of the present invention, a linear arrangement of RGB series is used as an example. The top and bottom electrodes (the first and second conductive layers) of each column of organic light emitting regions are electrically connected to a driving circuit 500, and a bias is applied thereon to force the blocks of organic light emitting layer 122, 124, 126 emitting desired colors of light. Moreover, each column of organic light emitting regions are controlled by the driving circuit 500 with sequential color mode to emit each color of organic light emitting regions by turns, i.e. in a sequence of R, G, B, R, G, B, . . . . The emitting frequency of each organic light emitting region is three times a scanning frequency, and the scanning frequency is higher than 60 Hz to input R, G, B signals into a scanned pixel during the scanning period, so that a persistence of dynamic color vision is produced to a viewer. If a persistence of static color vision is needed, the scanning frequency is not needed to be higher than 60 Hz.

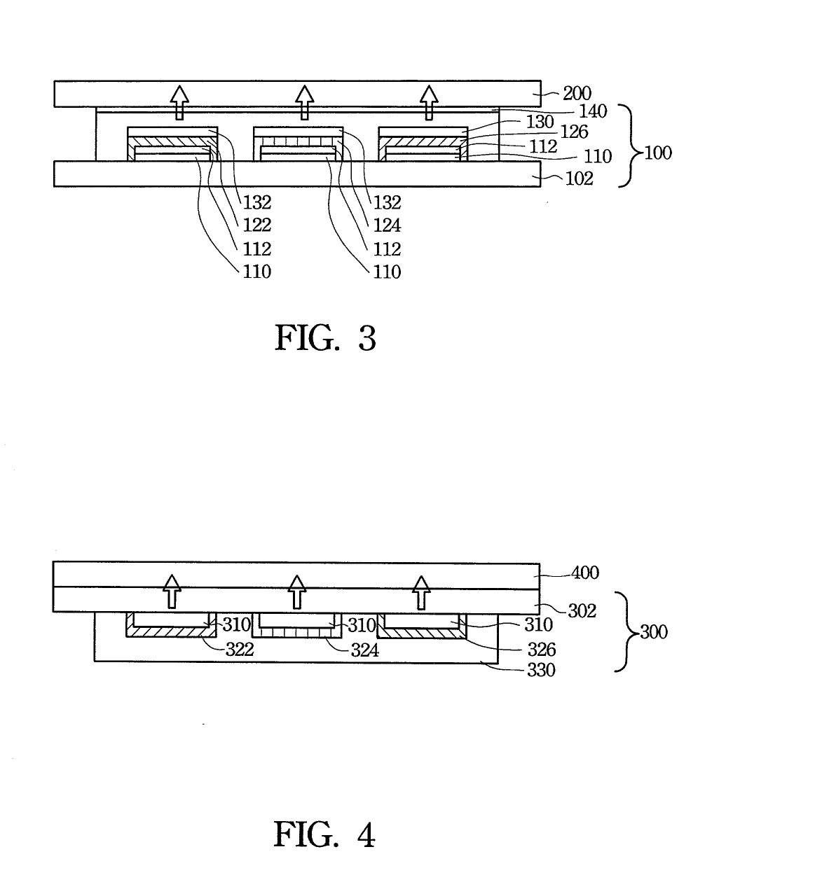

FIG. 3 is schematic cross-sectional view of a modified embodiment corresponding to the first preferred embodiment of the present invention. Wherein, the transparent substrate 102, the first conductive layer 110, the organic light emitting layer 122, 124, 126 and the second conductive layer 130 are the same as foregoing described. A electron transport layer (ETL) 112 made of such as Alq₃ can be inserted between the first conductive layer 110 and the organic light emitting layer 122, 124, 126 to improve the performance of electron injection. A hold transport layer (HTL) 132 made of such as diamine can be inserted between the organic light emitting layer 122, 124, 126 and the second conductive layer 130 to improve the performance of hole injection. In addition, a light scattering layer can be optionally formed on the second conductive layer 130 to scatter the light that emitted from the blocks of organic light emitting layer 122, 124, 126.

FIG. 4 is a schematic cross-sectional view of the second preferred embodiment of the present invention. The first conductive layer and the second conductive layer are exchanged to reverse the transmitting direction of the emitting light. Referring to FIG. 4, the organic light emitting backlight device 300 of the present invention comprises a transparent substrate 302. The transparent substrate 302 can be made of a high transparence material, such as glass, plastic, or quartz, etc. At least three blocks of first conductive layer 310 are formed on the transparent substrate 302 to serve as a hole injection layer (HIL), and all of the blocks of first conductive layer 310 are not contacted to each other. The blocks of first conductive layer 130 are made of a transparent conductive material with high work function, such as indium tin oxide (ITO).

At least three blocks of organic light emitting layer 322, 324, 326 are formed on the blocks of first conductive layer 310, and fully cover the blocks of first conductive layer 310, respectively. The blocks of organic light emitting layer 322, 324, 326 can be made of organic light emitting material or polymer light emitting material. The blocks of organic light emitting layer 322, 324, 326 respectively emit at least three different bandwidths of light. The at least three different bandwidths of light must be components for constructing a full color vision, for example, the light in red, green and blue (RGB) bandwidths, the light in cyan, magenta and yellow (CMY) bandwidths, or other component combination for full color vision.

A second conductive layer 330 is formed and fully covers the blocks of organic light emitting layer 322, 324, 326 to server as an electron injection layer (EIL). The second conductive layer 330 can be made of a conductive material with low work function, for example, lithium (Li), magnesium (Mg), calcium (Ca), and aluminum (Al), etc. Therefore, the light emitted from the blocks of organic light emitting layer 322, 324, 326 can be transmitted through the second conductive layer 330 to a liquid crystal displaying module 400. In the preferred embodiment of the present invention, the transparent conductive layer 300 is formed previously, and thereby the process of fabricating the organic light emitting backlight device will be simplified. As well known to a person of ordinary skill in the art, the liquid crystal displaying module 200 at least includes a liquid crystal layer, polarizers, and a switch circuit, etc., to control whether the light emitted from the organic light emitting backlight device 100 passes through the liquid crystal displaying module to the eyes of a viewer. The arrangement and operation mode of the organic light emitting backlight device of the present invention has been described in foregoing embodiment corresponding to FIG. 2, so that it is not discussed further in detail herein.

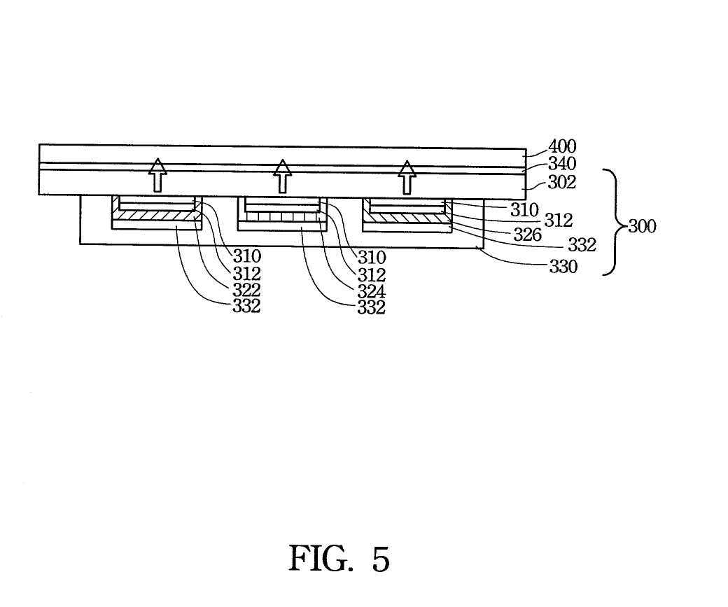

FIG. 5 is schematic cross-sectional view of a modified embodiment corresponding to the second preferred embodiment of the present invention. Wherein, the transparent substrate 302, the first conductive layer 310, the organic light emitting layer 322, 324, 326 and the second conductive layer 330 are the same as foregoing described. A hole transport layer (HTL) 312 made of such as diamine can be inserted between the first conductive layer 310 and the organic light emitting layer 322, 324, 326 to improve the performance of hole injection. A electron transport layer (ETL) 332 made of such as Alq₃ can be inserted between the organic light emitting layer 322, 324, 326 and the second conductive layer 330 to improve the performance of electron injection. In addition, a light scattering layer can be optionally inserted between the first conductive layer 310 and the transparent substrate 302, or inserted between the transparent substrate 302 and the liquid crystal displaying module 400, to scatter the light that emitted from the blocks of organic light emitting layer 322, 324, 326.

According to above description, the volume and weight of the organic light emitting backlight device of the present invention can be greatly decreased, and the opening ratio and total transmission percentage can be increased without using a color filter. Therefore, the present invention can provide a thin, light, powerless organic light emitting backlight device with high brightness, light uniformity and more selective size choice.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structure.

What is claimed is:

1. A color organic light emitting backlight device for liquid crystal display, comprising:
a transparent substrate;
at least three blocks of first conductive layer on the transparent substrate;
at least three blocks of organic light emitting layer on the blocks of first conductive layer and fully covering the blocks of first conductive layer, respectively, wherein the blocks of organic light emitting layer emit at least three different bandwidths of light by turns; and
a second conductive layer fully covering the blocks of organic light emitting layer.

2. The color organic light emitting backlight device for liquid crystal display according to claim 1, wherein the transparent substrate comprises a glass substrate.

3. The color organic light emitting backlight device for liquid crystal display according to claim 1, wherein the at least three different bandwidths of light comprises the light in red, green and blue bandwidths.

4. The color organic light emitting backlight device for liquid crystal display according to claim 1, wherein each of the at least three different bandwidths of light is emitted by turns with a frequency three times a scanning frequency.

5. The color organic light emitting backlight device for liquid crystal display according to claim 4, wherein the scanning frequency is higher than 60 Hz.

6. The color organic light emitting backlight device for liquid crystal display according to claim 1, further comprising a driving circuit that drives the blocks of organic light emitting layer to emit light by turns.

7. The color organic light emitting backlight device for liquid crystal display according to claim 1, wherein the arrangement of the blocks of first conductive layer and organic light emitting layer comprises linear arrangement.

8. The color organic light emitting backlight device for liquid crystal display according to claim 1, wherein one of the first conductive layer and the second conductive layer is a transparent conductive layer.

9. The color organic light emitting backlight device for liquid crystal display according to claim 8, wherein a material of the transparent conductive layer comprises indium tin oxide (ITO).

10. The color organic light emitting backlight device for liquid crystal display according to claim 8, further comprising a hole transport layer inserted between the transparent conductive layer and the organic light emitting layer.

11. The color organic light emitting backlight device for liquid crystal display according to claim 8, further comprising an electron transport layer inserted between the organic light emitting layer and the other conductive layer.

12. The color organic light emitting backlight device for liquid crystal display according to claim 8, further comprising a scattering layer set on the transparent conductive layer to diffuse the light emitted from the organic light emitting layer.

13. A color organic light emitting backlight device for liquid crystal display adapted for a transparent substrate, comprising:
at least three organic light emitting regions emitting at least three different bandwidths of light by turns, wherein each of the organic light emitting regions comprising:
a first conductive layer on the transparent substrate;
an organic light emitting layer on the first conductive layer and fully covering the first conductive layer; and
a second conductive layer on the organic light emitting layer and fully covering the organic light emitting layer.

14. The color organic light emitting backlight device for liquid crystal display according to claim 13, wherein the transparent substrate comprises a glass substrate.

15. The color organic light emitting backlight device for liquid crystal display according to claim 13, wherein the at least three different bandwidths of light comprises the light in red, green and blue bandwidths.

16. The color organic light emitting backlight device for liquid crystal display according to claim 13, wherein each of the at least three different bandwidths of light is emitted by turns with a frequency three times a scanning frequency.

17. The color organic light emitting backlight device for liquid crystal display according to claim 16, wherein the scanning frequency is higher than 60 Hz.

18. The color organic light emitting backlight device for liquid crystal display according to claim 13, further comprising a driving circuit that drives the blocks of organic light emitting layer to emit light by turns.

19. The color organic light emitting backlight device for liquid crystal display according to claim 13, the arrangement of the blocks of first conductive layer and organic light emitting layer comprises linear arrangement.

20. The color organic light emitting backlight device for liquid crystal display according to claim 13, wherein one of the first conductive layer and the second conductive layer is a transparent conductive layer.

21. The color organic light emitting backlight device for liquid crystal display according to claim 20, wherein a material of the transparent conductive layer comprises indium tin oxide (ITO).

22. The color organic light emitting backlight device for liquid crystal display according to claim 20, further comprising a hole transport layer inserted between the transparent conductive layer and the organic light emitting layer.

23. The color organic light emitting backlight device for liquid crystal display according to claim 20, further comprising an electron transport layer inserted between the organic light emitting layer and the other conductive layer.

24. The color organic light emitting backlight device for liquid crystal display according to claim 20, further comprising a scattering layer set on the transparent conductive layer to diffuse the light emitted from the organic light emitting layer.
